(19) United States
(12) Patent Application Publication
(10) Pub. No.: US 2025/0084108 A1
(43) Pub. Date: Mar. 13, 2025

(54) SILYLATING GRAFTING AGENTS, POLYMERS GRAFTED THEREWITH AND METHODS OF SYNTHESIS

(71) Applicant: BRIDGESTONE CORPORATION, Chuo-ku, Tokyo (JP)

(72) Inventors: Sem TAMANG, Stow, OH (US); Bret J. CHISHOLM, Peoria, IL (US)

(21) Appl. No.: 18/725,273

(22) PCT Filed: Dec. 29, 2022
(86) PCT No.: PCT/US2022/082530

§ 371 Date: Jun. 28, 2024

Related U.S. Application Data
(60) Provisional application No. 63/266,191, filed on Dec. 30, 2021.

(51) Int. Cl. C07F 7/08; C08C 19/25; C08G 81/02

(52) U.S. Cl. CPC C07F 7/0879; C08C 19/25; C08G 81/024

(57) ABSTRACT

Silylating grafting agents and methods for synthesizing the same. The grafting agents are used to produce functionalized polydiene polymers by modifying the backbone of the polymer. Methods for functionalizing a polydiene post-polymerization using hydrosilylation are described. Hydrosilylation provides an advantage of incorporating multiple functional groups on the backbone of the polymer which lead to improved properties, such as rolling resistance, wet traction and polymer filler interaction.

### FIELD OF THE INVENTION

The present invention relates to silylating grafting agents and methods for synthesizing the same. The grafting agents are used to produce functionalized polydiene polymers by modifying the backbone of the polymer. Methods for functionalizing a polydiene post-polymerization using hydrosilylation are described. Hydrosilylation provides an advantage of incorporating multiple functional groups on the backbone of the polymer which lead to improved properties, such as rolling resistance, wet traction and polymer filler interaction.

### BACKGROUND OF THE INVENTION

Hydrosilylation as a methodology for functionalization is very well studied and has found wide-spread industrial application. It provides a facile way to incorporate silane functionality onto polymers. Many different silylating groups have been used in the art.

WO 2015/091020 relates to a method for synthesizing a modified polymer including epoxide groups along the polymer chain, by a hydrosilylation reaction of the unsaturations with a hydrosilane having an epoxide function in the presence of a suitable catalyst.

U.S. Pat. No. 9,315,600 relates to a method for producing a modified conjugated diene polymer comprising a polymerization step of obtaining a conjugated diene polymer containing a nitrogen atom in a polymer chain and an active end by copolymerizing a conjugated diene compound and a nitrogen atom-containing vinyl compound, or a conjugated diene compound, an aromatic vinyl compound and a nitrogen atom-containing vinyl compound by use of an alkali metal compound and/or an alkaline earth metal compound as a polymerization initiator, and a modification step of reacting a modifier.

U.S. 2016/0369015 relates to backbone-modified elastomeric polymers to polymer compositions comprising such modified polymers, to the use of such compositions in the preparation of vulcanized polymer compositions, and to articles prepared from the same. The modified polymers are reportedly useful in the preparation of vulcanized, i.e. cross-linked, elastomeric compositions having relatively low hysteresis loss. Such vulcanized compositions are reportedly useful in many articles, including tire treads having low heat build-up, low rolling resistance, good wet grip and ice grip, in combination with other physical and chemical properties, for example, abrasion resistance and tensile strength. Moreover, the unvulcanized polymer compositions reportedly exhibit processability.

EP 3394119 relates to a diene elastomer, characterized in that it comprises units derived from diene distributed along the chain carrying a pendant group of the following formula (I): * —SiR1 R2-A-B in which: A and B are such that the melting point of the non-hydrosilylated analog, HAB, is less than 70° C. and the elastomer comprises from 10 to 40% by weight of pendant groups of formula (I), relative to the total weight elastomer. A process for preparing such a diene elastomer, the compositions comprising it, in particular rubber compositions for tires, are disclosed.

### SUMMARY OF THE INVENTION

In view of the above, the art still needs unique silylating grafting agents that can incorporate multiple functional groups on the backbone of a polymer, preferably a polydiene polymer which provides improved properties in a vulcanized composition, such as rolling resistance, wet traction and polymer filler interaction. Advantageously, the hydrosilylation can be performed directly after polymerization of the polymer without having to redissolve the latter in an additional process step. Hydrosilylating the polymer directly in the polymerization solvent without having to redissolve the polymer is both time- and resource-saving.

According to one embodiment of the invention, a method for synthesizing a silylating grafting agent is provided, said method comprising the steps of: combining a siloxane, a compound having a vinyl group with substitution at one carbon atom of the double bond which in some embodiments preferably is a polar compound comprising an allyl group, and a catalyst suitable for facilitating reaction between the siloxane and the compound; and reacting the siloxane and the compound for a sufficient period of time to produce the grafting agent; wherein the siloxane has the following formula:

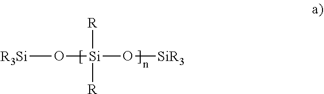

wherein n is an integer from 0 to 8, and each R individually is a hydrogen atom, a halogen atom, or a monovalent organic group, or where two or more R groups join to form a bond or a polyvalent organic group, with the proviso that each compound contains at least two R groups which are hydrogen atoms, bonded to different silicon atoms, or

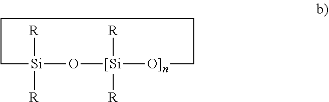

wherein R is a hydrogen atom, a halogen atom, or a monovalent organic group, and n is 2 to 5.

In another embodiment of the invention, a method for functionalizing a polydiene post-polymerization using hydrosilylation is provided, such method comprising the steps of: reacting i) the polydiene with ii) a silylating grafting agent having the formula:

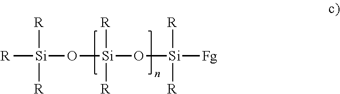

wherein n is an integer from 0 to 8, 25 or 150, and each R individually is a hydrogen atom, a halogen atom, a monovalent organic group, an Fg (as defined below), or where two or more R groups join to form a bond or a polyvalent organic group, with the proviso that at least one R is a hydrogen atom; wherein Fg is derived from a compound having the formula CH₂=C(R₁)(R₂), wherein at least one of R₁ and R₂ have a functionality that may participate in hydrogen bonding, a chemical reaction with a filler or polymer grafting and one of R1, and R₂ may be a hydrogen atom or an organic group, wherein in one preferred embodiment the compound has the formula CH₂=CHCH₂X—R, wherein X is O, S, or N, and wherein R is polyethylene oxide having from 3 to 100 repeat groups, or is derived from piperidine when X is N or is derived from bis(trimethylsilyl)amine when X is N, or

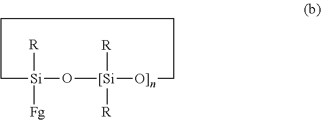

wherein R is a hydrogen atom, a halogen atom, a monovalent organic group or another Fg, and wherein Fg is as defined above, and n is 2 to 5.

In yet another embodiment of the invention, a hydrosilyl-functionalized polydiene polymer is provided, said polymer comprising: a reaction product of i) a polydiene and ii) a silylating grafting agent having the formula:

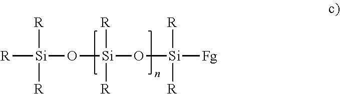

wherein n is an integer from 0 to 8, 25 or 150, and each R individually is a hydrogen atom, a halogen atom, a monovalent organic group, an Fg (as defined below) or where two or more R groups join to form a bond or a polyvalent organic group, with the proviso that at least one R is a hydrogen atom; wherein Fg is derived from a compound having the formula CH₂=C(R₁)(R₂), wherein at least one of R₁ and R₂ have a functionality that may participate in hydrogen bonding, a chemical reaction with a filler or polymer grafting and one of R1, and R₂ may be a hydrogen atom or an organic group, and wherein in one preferred embodiment the compound has the formula CH₂=CHCH₂X—R, wherein X is O or N, and wherein R is polyethylene oxide having from 3 to 100 repeat groups, or is derived from piperidine when X is N or is derived from bis(trimethylsilyl)amine when X is N, or

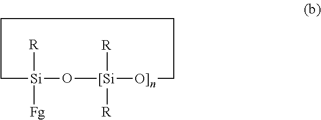

wherein R is a hydrogen atom, a halogen atom, a monovalent organic group, or another Fg, and wherein Fg is as defined above, and n is 2 to 5.

### DETAILED DESCRIPTION OF THE INVENTION

A silylating grafting agent is prepared by combining a siloxane and a compound having a vinyl group with substitution at one carbon atom of the double bond which in some embodiments preferably is a polar compound comprising an allyl group in the presence of a metal catalyst. Functionalized polymers, such as polydienes are produced by reacting the polymer with the silylating grafting agent in the presence of a catalyst.

### Synthesis of Silylating Grafting Agents

The silylating grafting agent is derived from a siloxane and a compound having a vinyl group with substitution at one carbon atom of the double bond which in some embodiments preferably is a polar compound comprising an allyl group reacted in the presence of a metal catalyst in an inert atmosphere.

### Siloxane

The siloxanes suitable for use in the present invention are characterized as including at least two hydrogen atoms which are covalently bonded to different silicon atoms. A first hydrogen atom participates in the reaction with the compound with a vinyl group with substitution at one carbon atom of the double bond which in some embodiments preferably is a polar compound comprising the allyl group and a second hydrogen atom participates in the hydrosilylation reaction with the polymer. In one or more embodiments, the siloxane is defined by the following formulae:

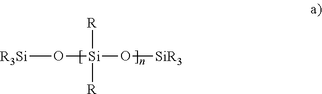

wherein n is an integer from 0 to 8, and each R, individually, is a hydrogen atom, halogen atom, or a monovalent organic group, or where two or more R groups join to form a bond or a polyvalent organic group, with the proviso that each siloxane contains at least two R groups which are hydrogen atoms, bonded to different silicon atoms. In a preferred embodiment n is 0. In one or more embodiments, n is 1 to 4, or

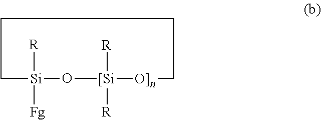

wherein R is a hydrogen atom, a halogen atom, or a monovalent organic group, and n is 2 to 5.

Non limiting examples of specific siloxanes include 1,1,3,3-tetramethyldisiloxane (TMDS), 1,1,3,3,5,5-hexamethyltrisiloxane, 1,1,3,3,5,5,7,7-octamethyltetrasiloxane, 1,1,1,3,5,7,7,7-octaakyltetrasiloxane, 1,1,3,3-tetraethyldisiloxane, 1,1,3,3,5,5-hexaethyltrisiloxane, 1,1,3,3,5,5,7,7-octaethyltetrasiloxane, 1,1,1,3,5,7,7,7-octaakyltetrasiloxane, 2,4,6,8-tetramethylcyclotetrasiloxane and 2,4,6-trimethylcyclotrisiloxane.

Compound with Vinyl Group

The compounds having a vinyl group with substitution at one carbon atom of the double bond is utilized to synthesize the grafting agent. In one embodiment the compound is a polar compound which comprises an allyl group which reacts with the siloxane under the reaction conditions. In one embodiment the compound has the formula CH₂=C(R₁)(R₂), wherein at least one of R₁ and R₂ have a functionality that may participate in hydrogen bonding, a chemical reaction with a filler or polymer grafting and one of R1, and R₂ may be a hydrogen atom or an organic group. In a preferred embodiment, the polar compound has the formula: CH₂=CHCH₂—XR, wherein X is O or N, and wherein R is polyethylene oxide having from 3 to 100 repeat groups. In another preferred embodiment, the polar compound is derived from piperidine. In still another preferred embodiment, the polar compound is derived from bis(trimethylsilyl)amine.

### Grafting Agent Catalyst

Catalysts which make use of a hydrosilylation reaction are selected from organo metal compounds, salts or metals, wherein the metal is, for example, Ni, Ir, Rh, Ru, Os, Pd and Pt compounds as taught in U.S. Pat. Nos. 3,159,601; 3,159,662; 3,419,593; 3,715,334; 3,775,452 and 3,814,730, which are herein fully incorporated by reference. In one preferred embodiment, the catalyst is chloro(1,5-cyclooctadiene)rhodium(I). The catalyst may be added to the reaction mixture in any customary form, however, preferably in the form of a solution in a solvent.

### Solvent

The reaction which forms the grafting agent may be performed in a suitable solvent or solvents. Suitable organic solvents include aromatic hydrocarbons, aliphatic hydrocarbons, and cycloaliphatic hydrocarbons. Examples of suitable aromatic hydrocarbon solvents include, but are not limited to benzene, toluene, ethylbenzene, diethylbenzene, naphthalenes, mesitylene, xylenes, and the like. Examples of suitable aliphatic hydrocarbon solvents include, but are not limited to, n-pentane, n-hexane, n-heptane, n-octane, n-nonane, n-decane, isopentane, hexanes, isohexanes, isopentanes, isooctanes, 2,2-dimethylbutane, petroleum ether, kerosene, petroleum spirits, and the like. Non-limiting examples of suitable cycloaliphatic hydrocarbon solvents include cyclopentane, cyclohexane, methylcyclopentane, methylcyclohexane, and the like. Still other suitable solvents include polar, aprotic solvents, such as tetrahydrofuran. Mixtures of the foregoing aromatic hydrocarbon solvents, aliphatic hydrocarbon solvents, and cycloaliphatic hydrocarbon solvents and polar, aprotic solvents can also be used. In certain embodiments, the preferred organic solvent includes an aliphatic hydrocarbon solvent, a cycloaliphatic hydrocarbon solvent, or mixtures thereof. Additional useful organic solvents suitable for use in forming the grafting agent are known to those of ordinary skill in the art.

### Synthesis of Grafting Agents

A suitable reaction vessel is charged with a desired amount of siloxane and compound having a vinyl group with substitution of one carbon atom of the double bond. In one or more embodiments, a siloxane is used in a molar ratio in relation to the polar compound that ranges generally from greater than 1:1 to about 5:1, desirably greater than 1.25:1 to about 4:1 and preferably from about 1.5:1 to about 2.5:1, with 2:1 being most preferred. In one or more embodiments, the reaction vessel is cooled as the reaction is exothermic in nature. Thereafter, the catalyst, preferably in one embodiment dissolved in a suitable solvent, is added to the vessel. An inert atmosphere is utilized in one or more embodiments. Preferably the reaction mixture is agitated or otherwise mixed during reaction. The reaction mixture is allowed to warm up to a temperature, such as room temperature, or a temperature of about 25° C. to about 100° C. over a period of time such as about 3 to about 5 hours. The reaction vessel is vented during reaction to prevent excess buildup of H2 gas.

If desired, additional steps can be implemented to remove the metal catalyst and purify the crude product. For example, after reaction, activated charcoal can be added to the reaction mixture and stirred for a period of time, for example about 1 hour in some embodiments. The mixture can then be passed over a pad of basic alumina with a hydrocarbon-based solvent as eluent, for example anhydrous pentane. The eluent can be further processed and concentrated under vacuo to yield the silylating grafting agent.

### Silylating Grafting Agent

The resulting silylating grafting agent has the formula:

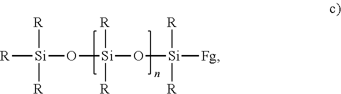

wherein each R and n are as defined hereinabove with the proviso that at least one R is a hydrogen atom, wherein Fg is derived from a compound having the formula CH₂=CHCH₂X—R, wherein X is O or N, and wherein R is polyethylene oxide having from 3 to 100 repeat groups, or is derived from piperidine when X is N or is derived from bis(trimethylsilyl)amine when X is N, or

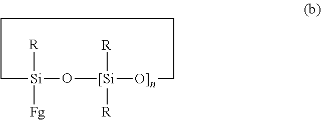

wherein R is a hydrogen atom, a halogen atom, a monovalent organic group, or another Fg, and wherein Fg is as defined above, and n is 2 to 5.
   Hydrosilylation of Polymer with Grafting Agent

The grafted polymer of the present invention is the reaction product of a polydiene polymer and the silylating grafting agent described herein. In addition to adding pendant silicon atoms to the polymer, the grafting agent also includes the herein-described functional group(s).

The polymer comprises pendant groups or unsaturations at one or more places on the main chain of the polymer. The term “graft” or the like as utilized herein should be understood to mean a pendant or side group fixed to the main chain of the polymer which arises from grafting by hydrosilylation of the grafting agent. Thus, according to the invention, the hydrosilane of the grafting agent reacts by hydrosilylation with the unsaturation of the polydiene polymer.

### Polydiene Polymer

When utilized herein, the term “polymer” is defined as a homopolymer, namely polymers formed from the same monomers, as well as a copolymer, namely polymers formed from two or more different monomers.

The ungrafted polymer, which is subjected to backbone modification in the present invention, is a homopolymer of a diene, or a copolymer of a first diene monomer and one or more second comonomers selected from a second diene monomer and aromatic vinyl compounds.

Examples of suitable dienes include, but are not limited to, (1,3-butadiene), 2-(C1-C5 alkyl)-1,3-butadiene such as isoprene (2-methyl-1,3-butadiene), 2,3-dimethyl-1,3-butadiene, 1,3-pentadiene, 2,4-hexadiene, 1,3-hexadiene, 1,3-heptadiene, 1,3-octadiene, 2-methyl-2,4-pentadiene, cyclopentadiene, 2,4-hexadiene, 1,3-cyclohexadiene and 1,3-cyclooctadiene. As noted above, two or more conjugated dienes may be utilized in combination to form the polymer. In one or more embodiments, butadiene is present in the polydiene.

Examples of aromatic vinyl compounds suitable for use in the polymer include monovinylaromatic compounds, i.e. compounds having a single vinyl group attached to an aromatic group, and di- or higher vinylaromatic compounds which have two or more vinyl groups attached to an aromatic group. Exemplary aromatic vinyl compounds include styrene, C1-C4 alkyl-substituted styrene such as 2-methylstyrene, 3-methylstyrene, 4-methylstyrene, 2,4-dimethylstyrene, 2,4,6-trimethylstyrene, alpha-methylstyrene, 2,4-diisopropylstyrene and 4-tert-butylstyrene, stilbene, vinyl benzyl dimethylamine, (4-vinylbenzyl)dimethyl aminoethyl ether, N,N-dimethylaminoethyl styrene, tert-butoxystyrene, vinylpyridine, and divinylaromatic compounds such as 1,2-divinylbenzene, 1,3-divinylbenzene and 1,4-divinylbenzene. Two or more aromatic vinyl compounds may be used in combination. A preferred aromatic vinyl compound is a monovinylaromatic compound, more preferably styrene.

In some embodiments, the aromatic vinyl compound constitutes from 5 wt. % to 50 wt. % and preferably from 10 wt. % to 45 wt. % of the total monomer content of the polymer.

Preferred polydiene polymers include styrene-butadiene rubber (SBR), poly(1,3-butadiene, butyl rubber (BR) and isoprene rubber (IR).

The polymers suitable for use in the present invention may be obtained according to conventional polymerization techniques utilizing conventional additives is well known to those of ordinary skill in the art. The polymers may for example be block, random, sequential or microsequential, and be prepared in dispersion, emulsion or solution, for example.

The polymerization can be conducted under batch, continuous or semi-continuous conditions. The polymerization process is preferably conducted as a solution polymerization, wherein the resulting polymer is substantially soluble in the reaction mixture, or as a suspension/slurry polymerization, wherein the polymer is substantially insoluble in the reaction medium. As the polymerization solvent, a hydrocarbon solvent is conventionally used which does not deactivate the initiator, catalyst or active polymer chain.

### Hydrosilylization of Polymer

In an important aspect of the present invention, the grafting of the grafting agent onto the polymer can take place in the polymerization solvent utilized to prepare the polymer. When this method is utilized, both time and expense are saved as the polymer need not be dried and subsequently resolvated prior to reaction with the grafting agent.

Preferably, the majority of the polymer chain ends, i.e. greater than 50%, especially at least 70%, preferably at least 80%, are terminated prior to the addition of the grafting agent; that is, living polymer chain ends are preferably not present and are not capable of reacting with the grafting agent in a polymer chain end modification reaction. Termination of the polymer chain ends can be affected by the action of a coupling agent, quenching agent, or chain terminator, by chain-end functionalization or by other means, such as impurities in the polymerization process or by inter- or intra-chain reactions.

In one or more embodiments, a quenching agent can protonate a chain end of the living polymer. The quenching agent may include a protic compound, which includes, but is not limited to, an alcohol, a carboxylic acid, an inorganic acid, water, or a mixture thereof. In particular embodiments, quenching with an alcohol, such as isopropanol, is employed since it has been observed that the use of isopropyl alcohol contributes to certain desirable properties in the final polymer, such as desirable cold flow. An antioxidant such as 2,6-di-tert-butyl-4-methylphenol may be added along with, before, or after the addition of the quenching agent. In certain embodiments, the quenching agents and/or antioxidants are selected to limit interference with the hydrosilylation reaction. The amount of the antioxidant employed may be in the range of 0.2% to 1% by weight of the polymer.

In one or more embodiments, the living polymer can be terminated with a compound that will impart a functional group to the terminus of the polymer, thereby causing the resulting polymer to carry at least one additional functional group.

Useful terminating agents include those conventionally employed in the art. Non-limiting examples of compounds that have been used to end-functionalize living polymers include carbon dioxide, benzophenones, benzaldehydes, imidazolidones, pyrrolidinones, carbodiimides, ureas, isocyanates, and Schiff bases including those disclosed in U.S. Pat. Nos. 3,109,871, 3,135,716, 5,332,810, 5,109,907, 5,210,145, 5,227,431, 5,329,005, 5,935,893, which are incorporated herein by reference. Additional examples include trialkyltin halides such as tributyltin chloride, as disclosed in U.S. Pat. Nos. 4,519,431, 4,540,744, 4,603,722, 5,248,722, 5,349,024, 5,502,129, and 5,877,336, which are incorporated herein by reference. Other examples include cyclic amino compounds such as hexamethyleneimine alkyl chloride, as disclosed in U.S. Pat. Nos. 5,786,441, 5,916,976 and 5,552,473, which are incorporated herein by reference. Other examples include N-substituted aminoketones, N-substituted thioaminoketones, N-substituted aminoaldehydes, and N-substituted thioaminoaldehydes, including N-methyl-2-pyrrolidone or dimethylimidazolidinone (i.e., 1,3-dimethylethyleneurea) as disclosed in U.S. Pat. Nos. 4,677,165, 5,219,942, 5,902,856, 4,616,069, 4,929,679, 5,115,035, and 6,359,167, which are incorporated herein by reference. Additional examples include cyclic sulfur-containing or oxygen containing azaheterocycles such as disclosed in U.S. Publication No. 2006/0074197 A1, U.S. Publication No. 2006/0178467 A1 and U.S. Pat. No. 6,596,798, which are incorporated herein by reference. Other examples include boron-containing terminators such as disclosed in U.S. Pat. No. 7,598,322, which is incorporated herein by reference. Still other examples include cyclic siloxanes such as hexamethylcyclotrisiloxane, including those disclosed in copending U.S. Publication No. 2007/0149744 A1, which is incorporated herein by reference. Further, other examples include α-halo-ω-aminoalkanes, such as 1-(3-bromopropyl)-2,2,5,5-tetramethyl-1-aza-2,5-disilacyclopentane, including those disclosed in U.S. Publication Nos. 2007/0293620 A1 and 2007/0293620 A1, which are incorporated herein by reference. Further examples include γ-mercapto-propyltrimethoxysilane, vinyltriethoxy silane, vinyltrimethoxy silane, and vinylmethyldimethoxy silane. Still further examples include 3-bis(trimethylsilyl)aminopropyl-methyldiethoxysilane and 3-(1,3-dimethylbutylidene)aminopropyltriethoxysilane. Additional terminators include trialkylsilyl halides, such as, but not limited to, trimethylsilyl chloride (TMSCl); triarylsilyl halides, such as, but not limited to, triphenylsilyl chloride; and a mixture of alkyl-arylsilyl halides, such as tert-butyldiphenylsilyl chloride, tris(Dimethylamino)chlorosilane, and 3-cyanopropylaminodimethylchlorosilane. The foregoing listing of terminating agents is not to be construed as limiting but rather as enabling. While a terminating agent can be employed, practice of the present invention is not limited to a specific agent or class of such compounds.

In one or more embodiments, the living polymer can be coupled to link two or more living polymer chains together. In certain embodiments, the living polymer can be treated with both coupling and terminating agents, which serve to couple some chains and terminate other chains. The combination of coupling agent and terminating agent can be used at various molar ratios. Although the terms coupling and terminating agents have been employed in this specification, those skilled in the art appreciate that certain compounds may serve both functions. That is, certain compounds may both couple and provide the polymer chains with a functional group. Those skilled in the art also appreciate that the ability to couple polymer chains may depend upon the amount of coupling agent reacted with the polymer chains. For example, advantageous coupling may be achieved where the coupling agent is added in a one to one ratio between the equivalents of a metal such as lithium on the initiator and equivalents of leaving groups (e.g., halogen atoms) on the coupling agent. Non-limiting examples of coupling agents include metal halides, metalloid halides, alkoxysilanes, and alkoxystannanes.

In one or more embodiments, metal halides or metalloid halides may be selected from the group comprising compounds expressed by the formula (1) R*ₙM¹Y₍₄₋ₙ₎, the formula (2) M¹Y₄, and the formula (3) M²Y₃, where each R* is independently a monovalent organic group having 1 to 20 carbon atoms, M¹ is a tin atom, silicon atom, or germanium atom, M² is a phosphorous atom, Y is a halogen atom, and n is an integer of 0-3.

Exemplary compounds expressed by the formula (1) include halogenated organic metal compounds, and the compounds expressed by the formulas (2) and (3) include halogenated metal compounds.

In the case where M¹ represents a silicon atom, the compounds expressed by the formula (1) can be, for example, triphenylchlorosilane, trihexylchlorosilane, trioctylchlorosilane, tributylchlorosilane, trimethylchlorosilane, diphenyldichlorosilane, dihexyldichlorosilane, dioctyldichlorosilane, dibutyldichlorosilane, dimethyldichlorosilane, methyltrichlorosilane, phenyltrichlorosilane, hexyltrichlorosilane, octyltrichlorosilane, butyltrichlorosilane, methyltrichlorosilane and the like. Furthermore, silicon tetrachloride, silicon tetrabromide and the like can be exemplified as the compounds expressed by the formula (2).

In the case where M¹ represents a germanium atom, the compounds expressed by the formula (1) can be, for example, triphenylgermanium chloride, dibutylgermanium dichloride, diphenylgermanium dichloride, butylgermanium trichloride and the like. Furthermore, germanium tetrachloride, germanium tetrabromide and the like can be exemplified as the compounds expressed by the formula (2). Phosphorous trichloride, phosphorous tribromide and the like can be exemplified as the compounds expressed by the formula (3). In one or more embodiments, mixtures of metal halides and/or metalloid halides can be used.

In one or more embodiments, alkoxysilanes or alkoxystannanes may be selected from the group comprising compounds expressed by the formula (4) R*ₙM¹(OR\hat{ })₄₋ₙ, where each R* is independently a monovalent organic group having 1 to 20 carbon atoms, M¹ is a tin atom, silicon atom, or germanium atom, OR\hat{ } is an alkoxy group where R\hat{ } is a monovalent organic group, and n is an integer of 0-3.

Exemplary compounds expressed by the formula (4) include tetraethyl orthosilicate, tetramethyl orthosilicate, tetrapropyl orthosilicate, tetraethoxy tin, tetramethoxy tin, and tetrapropoxy tin.

The addition of the grafting agent may be carried out before, after, or during the addition of a coupling agent (if used), and before, after, or during the addition of a chain end modifier (if used), and before, after, or during the addition of a chain terminator (if used). Preferably, the grafting agent is added after any addition of the coupling agent, the chain end modifier and the chain terminator.

The grafting agent may be directly added to the polymer solution (polymerization solution) without dilution (neat); however, it may be beneficial to add the grafting agent in solution. The amount of grafting agent added varies depending upon the monomer species, grafting agent species, reaction conditions and desired end properties, but is generally from about 1 wt. % to about 30 wt. %, desirably from about 2.5 wt. % to 20 wt. % and preferably from about 5 wt. % to about 15 wt. %, based on the weight of the polymer (i.e. unmodified polymer (homopolymer or copolymer) without any solvent, etc.

The hydrosilylation may be carried out in a temperature range of from generally from 50° C. to 120° C., desirably from 50° C. to 100° C., and preferably from 50° C. to 80° C.

There is generally no limitation for the duration and timing of the functionalization reaction. The polymer will be reacted with the grafting agent for a suitable period of time, as will be readily established by a person of ordinary skill in the art, generally ranging from about 0.5 hours to about 10 hours.

### Hydrosilylation Catalyst

The hydrosilylation reaction can be carried out as is known in the art and will usually be performed in the presence of a hydrosilylation catalyst. Two or more catalyst compounds may be used in combination. Catalysts as described above for producing the grafting agent can be utilized and are herein incorporated by reference. In one or more embodiments, preferred catalysts include Karstedt's catalyst. The catalyst may be added before, after or simultaneously with the addition of the grafting agent. The total amount of hydrosilylation catalyst will depend on the amount of grafting agent. At lower amount of the hydrosilylation catalyst, the conversion of the grafting agent may be too low, and higher amounts thereof may be economically disadvantageous.

### Polymerization/Hydrosilylation Solvent

As noted herein, polymerization of the monomers utilized to form the polydiene polymer is preferably performed in a solvent. In one or more embodiments, the hydrosilylation reaction is performed directly in the polymerization solvent. In other embodiments, a solvent other than or in addition to the polymerization solvent can be utilized.

Examples of solvents include, but are not limited to those solvents described hereinabove with respect to preparation of the grafting agent. Said solvents are herein incorporated by reference.

### Grafted Polymer

The degree of grafting may be adjusted in a manner known by one of ordinary skill in the art, by varying various operating conditions, for example the amount of molecules to be grafted, the reaction temperature and reaction time.

The reaction of the grafting agent with the polydiene polymer results in a pendant graft bearing one or more functional groups connected to a silicon atom derived from the siloxane, such as TMDS.

More particularly, the pendant group attached to the backbone of the polymer has the following formula:

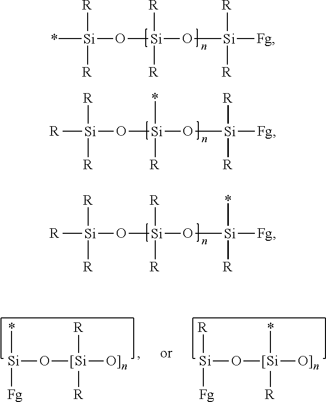

wherein R and Fg are as defined above and wherein * denotes a connection point with the polymer chain.

Generally, the average number of grafted units per chain is from about 0.25 to about 15, alternatively from about 2 to about 8. When the functional group includes ethylene oxide units, it has been found that grafting of the ethylene oxide units onto a main chain ranges generally from about 0.5 wt. % to about 10 wt. %, and preferably from about 0.6 wt. % to about 4.5 wt. %.

In embodiments where the functional group includes a nitrogen atom, grafting of nitrogen containing functional groups onto the main chain varies generally from about 50 ppm to about 2200 ppm N/chain.

In embodiments, the hydrosilyl-functionalized polydiene polymer may have a weight average molecular weight M_{w} of about 75,000 g/mol to about 1,000,000 g/mol. In embodiments, the functionalized conjugated diene may have a weight average molecular weight M_{w} greater than or equal to 75,000 g/mol, greater than or equal to 100,000 g/mol, greater than or equal to 200,000 g/mol, or even greater than or equal to 300,000 g/mol. In embodiments, the functionalized conjugated diene may have a weight average molecular weight M_{W} less than or equal to 1,000,000 g/mol, less than or equal to 800,000 g/mol, less than or equal to 600,000 g/mol, or even less than or equal to 400,000 g/mol.

In embodiments, the functionalized conjugated diene polymer may have a molecular weight M_{w} from about 75,000 g/mol to about 1,000,000 g/mol, from about 75,000 g/mol to about 800,000 g/mol, from about 75,000 g/mol to about 600,000 g/mol, from about 75,000 g/mol to about 400,000 g/mol, from about 100,000 g/mol to about 1,000,000 g/mol, from about 100,000 g/mol to about 800,000 g/mol, from about 100,000 g/mol to about 600,000 g/mol, from about 100,000 g/mol to about 400,000 g/mol, from about 200,000 g/mol to about 1,000,000 g/mol, from about 200,000 g/mol to about 800,000 g/mol, from about 200,000 g/mol to about 600,000 g/mol, from about 200,000 g/mol to about 400,000 g/mol, from about 300,000 g/mol to about 1,000,000 g/mol, from about 300,000 g/mol to about 800,000 g/mol, from about 300,000 g/mol to about 600,000 g/mol, or even from about 300,000 g/mol to about 400,000 g/mol, or any and all sub-ranges formed from any of these endpoints. The weight average molecular weight Mw is determined by gel permeation chromatography using a Tosoh Ecosec HLC-8320 GPC system and Tosoh TSKgel GMHxI-BS columns with THF as a solvent. PS calibrated and referenced.

In embodiments, the hydrosilyl-functionalized polydiene polymer may have a number average molecular weight Mn of about 75,000 g/mol to about 1,000,000 g/mol. In embodiments, the functionalized conjugated diene may have a number average molecular weight Mn greater than or equal to 75,000 g/mol, greater than or equal to 100,000 g/mol, greater than or equal to 200,000 g/mol, or even greater than or equal to 300,000 g/mol. In embodiments, the functionalized conjugated diene may have a number average molecular weight Mn less than or equal to 1,000,000 g/mol, less than or equal to 800,000 g/mol, less than or equal to 600,000 g/mol, or even less than or equal to 400,000 g/mol. In embodiments, the functionalized conjugated diene polymer may have a molecular weight Mn from about 75,000 g/mol to about 1,000,000 g/mol, from about 75,000 g/mol to about 800,000 g/mol, from about 75,000 g/mol to about 600,000 g/mol, from about 75,000 g/mol to about 400,000 g/mol, from about 100,000 g/mol to about 1,000,000 g/mol, from about 100,000 g/mol to about 800,000 g/mol, from about 100,000 g/mol to about 600,000 g/mol, from about 100,000 g/mol to about 400,000 g/mol, from about 200,000 g/mol to about 1,000,000 g/mol, from about 200,000 g/mol to about 800,000 g/mol, from about 200,000 g/mol to about 600,000 g/mol, from about 200,000 g/mol to about 400,000 g/mol, from about 300,000 g/mol to about 1,000,000 g/mol, from about 300,000 g/mol to about 800,000 g/mol, from about 300,000 g/mol to about 600,000 g/mol, or even from about 300,000 g/mol to about 400,000 g/mol, or any and all sub-ranges formed from any of these endpoints. The number average molecular weight Mn is determined by gel permeation chromatography using a Tosoh Ecosec HLC-8320 GPC system and Tosoh TSKgel GMHxI-BS columns with THF as a solvent. PS calibrated and referenced.

For the avoidance of doubt, it is noted that the invention relates to all possible combinations of features described herein, preferred in particular are those combinations of features that are present in the claims. It will therefore be appreciated that all combinations of features relating to the compositions according to the invention; all combinations of features relating to the processes according to the invention and all combinations of features relating to the compositions according to the invention and features relating to the processes according to the invention are described herein.

It is further noted that the term ‘comprising’ does not exclude the presence of other elements. However, it is also to be understood that a description on a product comprising certain components also discloses a product consisting of these components. Similarly, it is also to be understood that a description on a process comprising certain steps also discloses a process consisting of these steps. The product/composition consisting of these components may be advantageous in that it offers a simpler, more economical process for the preparation of the product/composition. The process consisting of these steps may be advantageous in that it offers a simpler, more economical process.

### Examples

The examples set forth below are provided to illustrate the silylating grafting agents, methods of synthesis thereof as well as polymers grafted therewith and methods for producing the grafted polymers. The examples are not intended to limit the scope of the invention.

The following raw materials were utilized for the examples:

TABLE 1

| Compounds | Source |
|---|---|
| Allyloxy(triethylene oxide)methyl ether | Gelest |
| Allloxy(polyethylene oxide), methyl ether (9-12 EO) | Gelest |
| Allyloxy(polyethylene oxide), methyl ether (20-55-EO) | Gelest |
| 1,1,3,3-tetramethyldisiloxane (TMDS) | Sigma Aldrich |
| Trimethylsilyl Chloride (TMSCl) | Sigma Aldrich |
| Platinum(0)-1,3-divinyl-1,1,3,3-tetramethyldisiloxane | Sigma Aldrich |
| complex solution in xylene Pt ~2% | |
| anhydrous pentane | Sigma Aldrich |
| anhydrous dichloromethane | Sigma Aldrich |
| 1-allylpiperidine | Sigma Aldrich |
| N-allyl-N,N-bis(trimethylsilyl)amine | Sigma Aldrich |
| CDCl₃ | Sigma Aldrich |

The following test protocols were used for testing:

TABLE 2

| Test | Units | Test Method |
|---|---|---|
| Number Average | Mn | Gel permeation chromatography (GPC) |
| Molecular | | using a Tosoh Ecosec HLC-8320 GPC |
| Weight | | system and Tosoh TSKgel GMHxl-BS |
| | | columns with THF as a solvent. PS |
| | | calibrated and referenced. |
| Weight Average | Mw | Gel permeation chromatography (GPC) |
| Molecular | | using a Tosoh Ecosec HLC-8320 GPC |
| Weight | | system and Tosoh TSKgel GMHxl-BS |
| | | columns with THF as a solvent. PS |
| | | calibrated and referenced. |
| Styrene Content | % | 400 MHz NMR using CDCL₃ as solvent |
| Vinyl Content | % | 400 MHz NMR using CDCL₃ as solvent |
| Chemical | — | 400 MHz NMR using CDCL₃ as solvent |
| Structures | | |
| Mooney | (ML₁₊₄) | 100° C. with Monsanto Mooney viscometer |
| viscosities | | with a large rotor, one minute warm-up time, |
| | | and a four-minute running time |
| Tg | ° C. | Differential scanning calorimetry (DSC) |
| | | using a starting temperature of 23° C., |
| | | heating to 200° C. at a 10° C./min ramp |
| | | rate, cooling to −120° C., and reheating |
| | | to 200° C. at a 10° C./min ramp rate |

### Grafting Agent Synthesis

### Example 1: Synthesis of TMDS-PEG₃

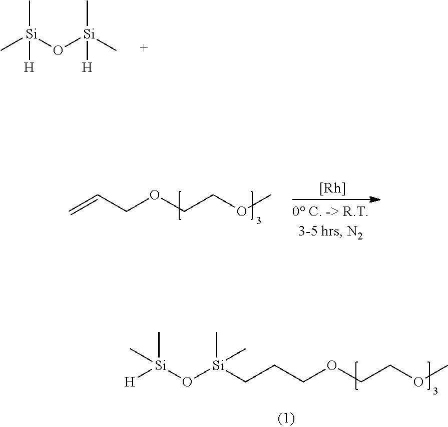

A 500 mL oven dried three neck flask was charged with allyloxy(triethylene oxide) methyl ether (25 g, 0.122 mols), 1,1,3,3-tetramethyldisiloxane (32.9 g, 43.2 mL, 0.245 mols), and a stir bar. The flask was then cooled down to 0° C. in an ice bath and chloro(1,5-cyclooctadiene)rhodium(I) (5 mg, 0.01 mmols) dissolved in anhydrous toluene (1 mL) was added to the reaction mixture under an inert atmosphere. The reaction was then allowed to warm up to room temperature over a period of time under a stream of inert gas. The flask was vented during reaction to prevent access buildup of H2 gas. The color of the reaction mixture changed from light yellow to reddish orange as the reaction progressed. After 5 hrs, activated charcoal (10 g) was added and the reaction mixture was stirred for an additional 1 hr. The black heterogenous mixture was then passed over a pad of basic alumina with anhydrous pentane (500 mL) as the eluent. The colorless eluent was concentrated under vacuo to yield a colorless liquid as a pure product (41 g, 98%). ¹H NMR (400 MHz, CDCl₃): 4.60 (1H, septet, Si—H), 3.60-3.57 (8H, multiplet), 3.54-3.46 (4H, multiplet), 3.34 (2H, triplet), 3.31 (3H, S) 1.57-1.50 (2H, multiplet), 0.47-0.42 (2H, multiplet), 0.10 (12H, dd).

### Example 2: Synthesis of TMDS-PEG₉₋₁₂

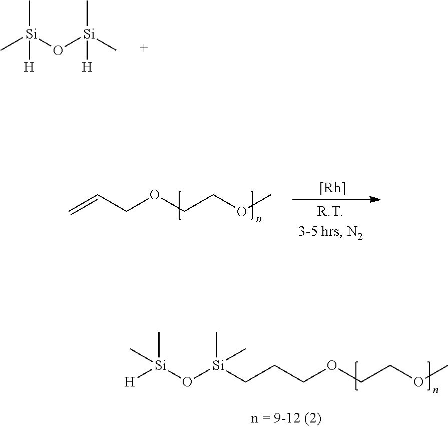

A 500 mL oven dried three neck flask was charged with allyloxy(polyethylene oxide), methyl ether (9-12 EO) (25 g, 0.045 mols), 1,1,3,3-tetramethyldisiloxane (12.21 g, 16.1 mL 0.091 mols), chloro(1,5-cyclooctadiene)rhodium(I) (5 mg, 0.01 mmols) dissolved in anhydrous toluene (1 mL), and a stir bar under an inert atmosphere. The flask was vented during reaction to prevent access buildup of H2 gas. The color of the reaction mixture changed from light yellow to reddish orange as the reaction progressed. After 5 hrs, activated charcoal (10 g) was added and the reaction mixture was stirred for an additional 1 hr. The black heterogenous mixture was then passed over a pad of basic alumina with anhydrous pentane (500 mL) as the eluent. The colorless eluent was concentrated under vacuo to yield a colorless liquid as a pure product (26.5 g, 85%). ¹H NMR of (2) (400 MHz, CDCl₃): 4.60 (1H, br, Si—H), 3.58-3.46 (42H, br), 3.36-3.29 (5H, br multiplet). 1.57-1.46 (2H, br multiplet), 0.47-0.39 (2H, br multiplet), 0.09 (6H, br), −0.01 (6H, br).

### Example 3: Synthesis of TMDS-PEG₂₀₋₅₅

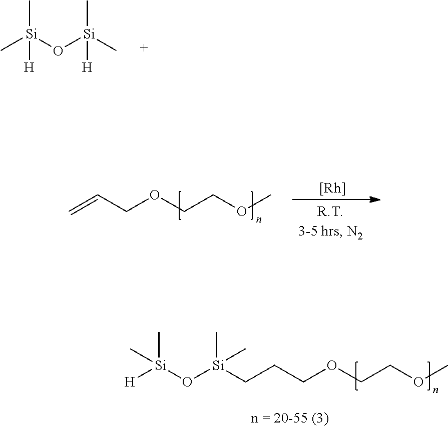

A 500 mL oven dried three neck flask was charged with allyloxy(polyethylene oxide), methyl ether (20-55 EO) (25 g, 0.025 mols), 1,1,3,3-tetramethyldisiloxane (6.72 g, 8.84 mL, 0.05 mols), chloro(1,5-cyclooctadiene)rhodium(I) (5 mg, 0.01 mols) dissolved in anhydrous toluene (1 mL), and a stir bar under an inert atmosphere. The flask was vented during reaction to prevent access buildup of H2 gas. The color of the reaction mixture changed from light yellow to reddish orange as the reaction progressed. After 5 hrs, activated charcoal (10 g) was added and the reaction mixture was stirred for an additional 1 hr. The black heterogenous mixture was then passed over a pad of basic alumina with anhydrous dichloromethane (500 mL) as the eluent. The colorless eluent was concentrated under vacuo to yield a colorless liquid as a pure product (10.1 g, 89.1%). ¹H NMR of (3) (400 MHz): 4.60 (1H, septet, Si—H), 3.58-3.46 (100H, multiplet), 3.40-3.30 (5H, multiplet), 1.6-1.5 (2H, multiplet), 0.51-0.42 (2H, multiplet), 0.09-0.00 (12H, multiplet).

### Example 4: Synthesis of TMDS-propylpiperidine

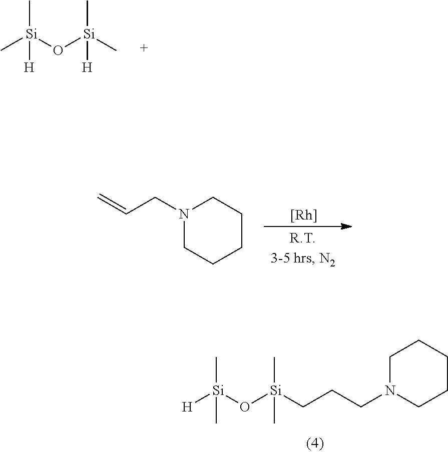

A 100 mL oven dried three neck flask was charged with 1-allylpiperidine (5 g, 0.04 mols), 1,1,3,3-tetramethyldisiloxane (10.7 g, 0.08 mols), chloro(1,5-cyclooctadiene)rhodium(I) (5 mg, 0.01 mols) dissolved in anhydrous toluene (1 mL), and a stir bar under an inert atmosphere. The flask was vented during reaction to prevent access buildup of H2 gas. The color of the reaction mixture changed from light yellow to reddish orange as the reaction progressed. After 5 hrs, activated charcoal (5 g) was added and the reaction mixture was stirred for an additional 1 hr. The black heterogenous mixture was then passed over a pad of basic alumina with anhydrous pentane (500 mL) as the eluent. The colorless eluent was concentrated under vacuo to yield a colorless liquid as a pure product (4.58 g, 44%). ¹H NMR of (4) (400 MHz, CDCl₃): 4.66 (1H, Si—H), 2.37 (4H, br)), 2.27 (2H, triplet), 1.64-1.38 (9H, multiplet), 0.48 (2H, triplet), 0.16 (6H, doublet), 0.08 (6H, doublet).

### Example 5: Synthesis of TMDS-propylNTMS

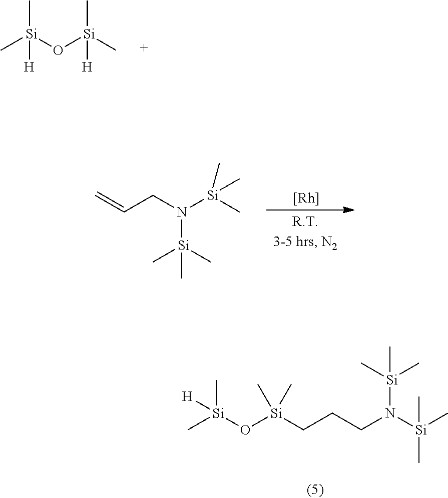

A 500 mL oven dried three neck flask was charged with N-allyl-N,N-bis(trimethylsilyl)amine (1.5 g, 0.07 mols), 1,1,3,3-tetramethyldisiloxane (2 g, 0.015 mols), chloro(1,5-cyclooctadiene)rhodium(I) (1 mg, 0.002 mmols) dissolved in anhydrous toluene (1 mL), and a stir bar under an inert atmosphere. The flask was vented during reaction to prevent access buildup of H2 gas. The color of the reaction mixture changed from light yellow to reddish orange as the reaction progressed. After 5 hrs, activated charcoal (10 g) was added and the reaction mixture was stirred for an additional 1 hr. The black heterogenous mixture was then passed over a pad of basic alumina with anhydrous pentane (500 mL) as the eluent. The colorless eluent was concentrated under vacuo to yield a colorless liquid as a pure product (2.2 g, 89%). ¹H NMR of (5) (400 MHz, CDCl₃) 4.69 (1H, Si—H), 2.71 (2H, triplet), 1.38-1.29 (2H, multiplet), 0.39 (2H, triplet), 0.19-0.16 (6H, doublet), 0.08-0.06 (24H, doublet).

Grafting of grafting agent including polar functional group onto polymers (styrene-butadiene copolymer (SBR)) via hydrosilylation

### Example 6: Synthesis of SBR Base Polymer Containing Styrene and Butadiene (Control)

A nitrogen purged jacketed steel reactor was charged with 2.78 lbs of anhydrous hexane, 0.44 lbs of a 33.7 wt. % styrene in hexane blend, and 6.75 lbs of a 20.0 wt. % butadiene in hexane blend. The jacket temperature of the reactor was set to 26.7° C. (80° F.) and the reactor was allowed to equilibrate. The reactor was then charged with n-butyllithium (2.27 mL, 2.5 M in hexane, 0.125 mmol per hundred gram monomer), followed by 2,2-bis(2′-tetrahydrofuryl)propane (1.10 mL, 1.6 M in hexane, 0.31 equiv vs Li) and the jacket temperature was set to 60° C. (140° F.). The batch temperature peaked at 85.7° C. (187.4° F.) after 26 minutes. After an additional 30 minutes, the polymer cement was dropped into a N₂ purged glass bottle. The bottle was agitated in an 80° C. water bath overnight, and the bottle was then quenched with 3 mL of an IPA/BHT solution (˜0.1 g BHT/mL IPA solution) and poured into IPA containing BHT, coagulated and drum dried.

The polymer was analyzed by GPC, NMR, and DSC with those values reported in Table 3.

### Example 7: Synthesis of Control SBR Terminated with TMSCl

The same procedure was followed as in Example 6, except that after the polymer cement was dropped into a N₂ purged glass bottle, trimethylsilyl chloride (TMSCl, 0.068 mL, 1 equiv vs Li) was charged. The bottle was agitated in an 80° C. water bath overnight, and the bottle was then quenched with 3 mL of an IPA/BHT solution (˜0.1 g BHT/mL IPA solution) and poured into IPA containing BHT, coagulated and drum dried. The polymer was analyzed by GPC, NMR, and DSC with those values reported in Table 3.

### Example 8: Synthesis of SBR-g-TMDSPEG₃ (1) without TMSCl as Terminator

The same procedure was followed as in Example 6, except that trimethylsilyl chloride (TMSCl) was not added as the terminator after the polymer cement was dropped into a N₂ purged glass bottle. The bottle was charged with polar grafting agent Example 1 (15.0 Wt. %, 9.2 g, 27.4 mmols), and platinum (0)-1,3-divinyl-1,1,3,3-tetramethyldisiloxane complex solution in xylene Pt ˜2% (0.05 mL amount). The bottle was agitated in a 50° C. water bath overnight, and the bottle was then quenched with 3 mL of an IPA/BHT solution (˜0.1 g BHT/mL IPA solution) and poured into IPA containing BHT, coagulated and drum dried. The polymer was analyzed by GPC, NMR, and DSC methods with those values reported in Table 3.

### Example 9: Synthesis of SBR-g-TMDSPEG₃ (1)

The same procedure was followed as in Example 7, except that after the charging of trimethylsilyl chloride (TMSCl) to the bottle, the bottle was charged with polar grafting agent Example 1 (10.0 Wt. %, 6.1 g, 18.1 mmols), and platinum (0)-1,3-divinyl-1,1,3,3-tetramethyldisiloxane complex solution in xylene Pt˜2% (0.05 mL amount). The bottle was agitated in a 50° C. water bath overnight, and the bottle was then quenched with 3 mL of an IPA/BHT solution (˜0.1 g BHT/mL IPA solution) and poured into IPA containing BHT, coagulated and drum dried. The polymer was analyzed by GPC, NMR and DSC methods with those values reported in Table 3.

### Example 10: Synthesis of SBR-g-TMDSPEG₃ (1)

The same procedure was followed as in Example 7, except that after the charging of trimethylsilyl chloride (TMSCl) to the bottle, the bottle was charged with polar grafting agent Example 1 (15.0 Wt. %, 7.5 g, 22.2 mmols), and platinum (0)-1,3-divinyl-1,1,3,3-tetramethyldisiloxane complex solution in xylene Pt ˜2% (1 mL). The bottle was agitated in an 80° C. water bath overnight, and the bottle was then quenched with 3 mL of an IPA/BHT solution (˜0.1 g BHT/mL IPA solution) and poured into IPA containing BHT, coagulated and drum dried. The polymer was analyzed by GPC, NMR, and DSC methods with those values reported in Table 3.

### Example 11: Synthesis of SBR-g-TMDSPEG₉₋₁₂ (2)

The same procedure was followed as in Example 7, except that after the charging of trimethylsilyl chloride (TMSCl) to the bottle, the bottle was charged with polar grafting agent Example 2 (15.0 Wt. %, 7.5 g, 11.0 mmols), and platinum (0)-1,3-divinyl-1,1,3,3-tetramethyldisiloxane complex solution in xylene Pt ˜2% (1 mL amount). The bottle was agitated in an 80° C. water bath overnight, and the bottle was then quenched with 3 mL of an IPA/BHT solution (˜0.1 g BHT/mL IPA solution) and poured into IPA containing BHT, coagulated and drum dried. The polymer was analyzed by GPC, NMR and DSC methods with those values reported in Table 3.

### Example 12: Synthesis of SBR-g-TMDSPEG₂₀₋₅₅ (3)

The same procedure was followed as in Example 7, except that after the charging of trimethylsilyl chloride (TMSCl) to the bottle, the bottle was charged with polar grafting agent Example 3 (5.0 Wt. %, 2.5 g, 2.20 mmols), and platinum (0)-1,3-divinyl-1,1,3,3-tetramethyldisiloxane complex solution in xylene Pt ˜2% (1 mL amount). The bottle was agitated in an 80° C. water bath overnight, and the bottle was then quenched with 3 mL of an IPA/BHT solution (˜0.1 g BHT/mL IPA solution) and poured into IPA containing BHT, coagulated and drum dried. The polymer was analyzed by GPC, NMR and DSC methods with those values reported in Table 3.

### Example 13: Synthesis of SBR-g-TMDSPEG₉₋₁₂ (2)

The same procedure was followed as in Example 7, except that after the charging of trimethylsilyl chloride (TMSCl) to the bottle, the bottle was charged with polar grafting agent Example 2 (10.0 Wt. %, 5.0 g, 7.3 mmols), and platinum (0)-1,3-divinyl-1,1,3,3-tetramethyldisiloxane complex solution in xylene Pt ˜2% (1 mL amount). The bottle was agitated in an 80° C. water bath overnight, and the bottle was then quenched with 3 mL of an IPA/BHT solution (˜0.1 g BHT/mL IPA solution) and poured into IPA containing BHT, coagulated and drum dried. The polymer was analyzed by GPC, NMR and DSC methods with those values reported in Table 3.

### Example 14: Synthesis of SBR Base Polymer Containing Styrene and Butadiene (Control)

A nitrogen purged jacketed steel reactor was charged with 2.78 lbs of anhydrous hexanes, 0.44 lbs of a 33.7 wt. % styrene in hexane blend, and 6.55 lbs of a 20.6 wt. % butadiene in hexanes blend. The jacket temperature of the reactor was set to 26.7° C. (80° F.) and the reactor was allowed to equilibrate. The reactor was then charged with n-butyllithium (2.27 mL, 2.5 M in hexane, 0.125 mmol per hundred gram monomer), followed by 2,2-bis(2′-tetrahydrofuryl)propane (1.10 mL, 1.6 M in hexane, 0.31 equiv vs Li) and the jacket temperature was set to 60° C. (140° F.). The batch temperature peaked at 80.2° C. (176.4° F.) after 31 minutes. After an additional 30 minutes, the polymer cement was dropped into a N₂ purged glass bottle. The bottle was agitated in a 50° C. water bath overnight, and the bottle was then quenched with 3 mL of an IPA/BHT solution (˜0.1 g BHT/mL IPA solution) and poured into IPA containing BHT, coagulated and drum dried. The polymer was analyzed by GPC, NMR, and DSC with those values reported in Table 4.

### Example 15: Synthesis of Control SBR Terminated with TMSCl

The same procedure was followed as in Example 13, except that after the polymer cement was dropped into a N₂ purged glass bottle, trimethylsilyl chloride (1 equiv vs Li) was charged. The bottle was agitated in a 50° C. water bath overnight, and the bottle was then quenched with 3 mL of an IPA/BHT solution (˜0.1 g BHT/mL IPA solution) and poured into IPA containing BHT, coagulated and drum dried. The polymer was analyzed by GPC, NMR, and DSC with those values reported in Table 4.

### Example 16: Synthesis of SBR-g-TMDSpropylpiperidine (4)

The same procedure was followed as in Example 14, except that after the charging of trimethylsilyl chloride (TMSCl) to the bottle, the bottle was charged with polar grafting agent Example 4 (5.0 Wt. %, 3.0 g, 11.7 mmols), and platinum (0)-1,3-divinyl-1,1,3,3-tetramethyldisiloxane complex solution in xylene Pt ˜2% (0.05 mL). The bottle was agitated in a 50° C. water bath overnight, and the bottle was then quenched with 3 mL of an IPA/BHT solution (˜0.1 g BHT/mL IPA solution) and poured into IPA containing BHT, coagulated and drum dried. The polymer was analyzed by GPC, NMR and DSC methods with those values reported in Table 4.

### Example 17: Synthesis of SBR-g-TMDS-propyINTMS (5)

The same procedure was followed as in Example 14, except that after the charging of trimethylsilyl chloride (TMSCl) to the bottle, the bottle was charged with polar grafting agent Example 5 (5.0 Wt. %, 3.0 g, 9 mmols), and platinum (0)-1,3-divinyl-1,1,3,3-tetramethyldisiloxane complex solution in xylene Pt ˜2% (0.05 mL). The bottle was agitated in a 50° C. water bath overnight, and the bottle was then quenched with 3 mL of an IPA/BHT solution (˜0.1 g BHT/mL IPA solution) and poured into IPA containing BHT, coagulated and drum dried. The polymer was analyzed by GPC, NMR and DSC methods with those values reported in Table 2.

TABLE 3
Analytical Characteristics of Hydrosilylated Polymers

| | Example # | | | | | | | |
|---|---|---|---|---|---|---|---|---|
| | 6-Control | 7-Control | 8 | 9 | 10 | 11 | 12 | 13 |
| Terminator | N/A | TMSCI | — | TMSCI | TMSCI | TMSCI | TMSCI | TMSCI |
| Catalyst loading (mL) | N/A | N/A | 0.05 | 0.05 | 1 | 1 | 1 | 1 |
| Temperature (° C.) | 80 | 80 | 50 | 50 | 80 | 80 | 80 | 80 |
| Polar grafting group | N/A | N/A | 1 | 1 | 1 | 2 | 3 | 2 |
| Silylating agent added (wt. %) | N/A | N/A | 15 | 10 | 15 | 15 | 5 | 10 |
| Grafted PEG Wt. % | N/A | N/A | 0.5 | 1.0 | 4 | 4.5 | 0.3 | 2.7 |
| # unit EO/chain | N/A | N/A | 7.4 | 16.4 | 67.9 | 21.2 | 0.6 | 12.9 |
| #PEG/chain | N/A | N/A | 3.8 | 7.8 | 32.1 | 9.2 | 0.5 | 6.6 |
| GPC-Base Peak | | | | | | | | |
| Mn (×10³) (PS Std; g/mol) | 175 | 187 | 178 | 183 | 198 | N/A | 185 | N/A |
| Mw (×10³) (PS Std; g/mol) | 198 | 196 | 194 | 194 | 209 | N/A | 197 | N/A |
| Mw/Mn (PS Std) | 1.12 | 1.05 | 1.08 | 1.06 | 1.05 | N/A | 1.06 | N/A |
| GPC-Coupled peak | | | | | | | | |
| Mn (×10³) (PS Std; g/mol) | 453 | 434 | 544 | 554 | 546 | N/A | 440 | N/A |
| Mw (×10³) (PS Std; g/mol) | 493 | 461 | 772 | 796 | 694 | N/A | 472 | N/A |
| Mw/Mn (PS Std) | 1.09 | 1.06 | 1.42 | 1.44 | 1.27 | N/A | 1.07 | N/A |
| GPC-Total | | | | | | | | |
| Mn (×10³) (PS Std; g/mol) | 195 | 196 | 256 | 263 | 270 | 140 | 191 | 166 |
| Mw (×10³) (PS Std; g/mol) | 248 | 217 | 460 | 467 | 411 | 160 | 211 | 182 |
| Mw/Mn (PS Std) | 1.26 | 1.11 | 1.80 | 1.78 | 1.52 | 1.14 | 1.11 | 1.09 |
| % Styrene | 12.2 | 11.5 | 10 | 10 | 11.9 | 11.6 | 11.5 | 11.7 |
| % 1,2 butadiene (vinyl) (BD = 100) | 45 | 45 | 40.1 | 39.3 | 41.6 | 42.0 | 44.8 | 43.4 |
| % 1,4 butadiene BD =100 | 55 | 55 | 59.6 | 58.9 | 53.9 | 53.3 | 54.8 | 53.8 |
| Tg (° C.) | −54.5 | −55.1 | −61.81 | −60.77 | −59.1 | −57.7 | −57.91 | −56.7 |
| % coupling | 17 | 8 | 46 | 45 | 42 | 0 | 5 | 0 |
| ML(1 + 4) | 18.44 | 13.73 | 32.42 | 24.88 | 54.49 | 25.73 | 15.66 | 26.04 |
| T₈₀ | 1.04 | 0.95 | 3.56 | 1.41 | 3.65 | 1.12 | 0.91 | 1.06 |

TABLE 2
Hydrosilylation of SBR with nitrogen
containing grafting agent (4-5)

| Example # | 14 | 15 | 16 | 17 |
|---|---|---|---|---|
| Terminator | N/A | TMSCl | TMSCl | TMSCl |
| Polar grafting group | N/A | N/A | 4 | 5 |
| Grafted Wt. % | N/A | N/A | 0.6 | 0.4 |
| Corrected TN (ppm) | N/A | N/A | 247.50 | 227.86 |
| N/Chain (TN) | N/A | N/A | 2.9 | 2.6 |
| GPC-Base Peak | | | | |
| Mn (X10³) (PS Std; g/mol) | 163 | 171 | 164 | 170 |
| Mw (X10³) (PS Std; g/mol) | 176 | 178 | 176 | 179 |
| Mw/Mn (PS Std) | 1.08 | 1.04 | 1.08 | 1.05 |
| GPC-Coupled peak | | | | |
| Mn (X10³) (PS Std; g/mol) | 379 | 388 | 376 | 409 |
| Mw (X10³) (PS Std; g/mol) | 400 | 418 | 400 | 462 |
| Mw/Mn (PS Std) | 1.05 | 1.08 | 1.06 | 1.13 |
| GPC Total | | | | |
| Mn (X10³) (PS Std; g/mol) | 170 | 188 | 175 | 194 |
| Mw (X10³) (PS Std; g/mol) | 192 | 217 | 202 | 238 |
| Mw/Mn (PS Std) | 1.13 | 1.15 | 1.15 | 1.22 |
| % Styrene | 11.1 | 11.0 | 12.2 | 11.8 |
| % 1,2 butadiene (vinyl) (BD = | 39.4 | 39.3 | 39.4 | 39.4 |
| 100) | | | | |
| % 1,4 butadiene (BD = 100) | 60.6 | 60.7 | 60.6 | 60.6 |
| Tg (° C.) | −60.6 | −59.5 | −60.1 | −60.3 |
| % coupling | 7 | 16 | 11 | 21 |
| ML(1 + 4) | 10.55 | 13.73 | 12.12 | 15.81 |
| T₈₀ | 0.93 | 0.96 | 0.99 | 1.30 |

In accordance with the patent statutes, the best mode and preferred embodiment have been set forth; the scope of the invention is not limited thereto, but rather by the scope of the attached claims.

What is claimed is:

1. A method for synthesizing a silylating grafting agent, comprising the steps of:
combining a siloxane, a compound having a vinyl group with substitution at one carbon atom of the double bond, and a catalyst suitable for facilitating reaction between the siloxane and the compound; and
reacting the siloxane and the polar compound for a sufficient period of time to produce the grafting agent;
wherein the siloxane has the following formula: 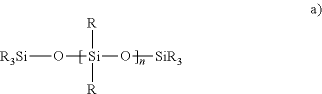
wherein n is an integer from 0 to 8, and each R individually is a hydrogen atom, a halogen atom, or a monovalent organic group, or where two or more R groups join to form a bond or a polyvalent organic group, with the proviso that each compound contains at least two R groups which are hydrogen atoms, bonded to different silicon atoms, or 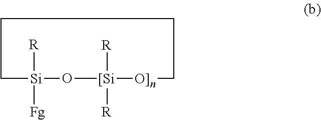
wherein R is a hydrogen atom, a halogen atom and n is 2 to 5.

2. The method according to claim 1, wherein the compound is a polar compound having the formula CH₂=CHCH₂X—R, wherein X is O or N, and wherein R is polyethylene oxide having from 3 to 100 repeat groups, or is derived from piperidine when X is N or is derived from bis(trimethylsilyl)amine when X is N,
wherein the catalyst is one or more of an organo metal compound, salt or metal, and
wherein the metal comprises Ni, Ir, Rh, Ru, Os, Pd and Pt compounds.

3. The method according to claim 2, wherein the polar compound is one or more of i.) allyloxy(polyethylene oxide) methyl ether wherein the polyethylene oxide has from 1 to 100 repeat units; ii.) 1-allylpiperidine; and iii.) N-allyl-N,N-bis(trimethylsilyl)amine, and
wherein the catalyst is one or more of chloro(1,5-cyclooctadiene)rhodium(I), platinum(0)-1,3-divinyl-1,1,3,3-tetramethyldisiloxane.

4-5. (canceled)

6. The method according to claim 1, wherein the reaction is performed at a temperature between about −5° C. and about 100° C.,
wherein the siloxane, compound and catalyst are combined in a reaction vessel, and
wherein the reaction vessel is vented to remove H2 gas, and further including the step of removing the catalyst after the reaction step.

7-8. (canceled)

9. The method according to claim 1, wherein the reaction is performed in solvent that is hexane or toluene.

10. A grafting agent produced by the method according to claim 1.

11. A method for functionalizing a polydiene post-polymerization using hydrosilylation, comprising the steps of:
reacting i) the polydiene with ii) a silylating grafting agent having the formula: 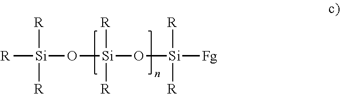
wherein n is an integer from 0 to 8, 25 or 150, and each R individually is a hydrogen atom, a halogen atom, a monovalent organic group, or an Fg (as defined below) or where two or more R groups join to form a bond or a polyvalent organic group, with the proviso that at least one R is a hydrogen atom;
wherein Fg is derived from a compound having the formula CH₂=C(R₁)(R₂), wherein at least one of R₁ and R₂ have a functionality that may participate in hydrogen bonding, a chemical reaction with a filler or polymer grafting and one of R₁, and R₂ may be a hydrogen atom or an organic group, or 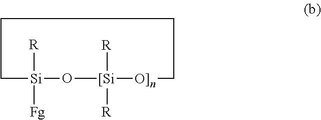
wherein R is a hydrogen atom, a halogen atom, a monovalent organic group, or another Fg, and wherein Fg is as defined above, and n is 2 to 5.

12. The method according to claim 11, wherein the compound has the formula CH₂=CHCH₂X—R, wherein X is O or N, and wherein R is polyethylene oxide having from 3 to 100 repeat groups, or is derived from piperidine when X is N or is derived from bis(trimethylsilyl)amine when X is N.

13. The method according to claim 11, wherein the polydiene comprises one or more of poly(1,3-butadiene) and a copolymer of butadiene and a comonomer that is one or more of an aromatic vinyl compound and a conjugated diene, wherein the aromatic vinyl compound is styrene, 2-methylstyrene, 3-methylstyrene, 4-methylstyrene, 2,4-dimethylstyrene, 2,4,6-trimethylstyrene, alpha-methylstyrene, 2,4-diisopropylstyrene, 4-tert-butylstyrene, stilbene, vinyl benzyl dimethylamine, (4-vinylbenzyl)dimethyl aminoethyl ether, N,N-dimethylaminoethyl styrene, tert-butoxystyrene, vinylpyridine, 1,2-divinylbenzene, 1,3-divinylbenzene or 1,4-divinylbenzene, or a combination thereof, wherein the aromatic vinyl compound constitutes from 0 to 50 wt. % of the total monomer content of the copolymer.

14. The method according to claim 13, wherein the conjugated diene is isoprene, 2,3-dimethyl-1,3-butadiene, 1,3-pentadiene, 2,4-hexadiene, 1,3-hexadiene, 1,3-heptadiene, 1,3-octadiene, 2-methyl-2,4-pentadiene, cyclopentadiene, 2,4-hexadiene, 1,3-cyclohexadiene or 1,3-cyclooctadiene, or a combination thereof, and
wherein the copolymer is styrene-butadiene rubber, butadiene-isoprene rubber or butadiene-isoprene-styrene rubber, wherein when styrene is present the styrene content is of from 5 wt. % to 50 wt. % by weight of total monomer content of the copolymer.

15. (canceled)

16. The method according to claim 11, further including the step of terminating a living chain end of the polymer with a terminator and/or coupling two or more living chains together with a coupling agent and/or quenching a living chain end of the polymer with a quenching agent prior to reacting the i) polydiene with ii) the silylating grafting agent.

17. The method according to claim 16 wherein the terminator is one or more of carbon dioxide, a benzophenone, a benzaldehyde, an imidazolidone, a pyrrolidinone, a carbodiimide, an urea, a isocyanate, a Schiff base, a trialkyltin halide, a cyclic amino compound, a N-substituted aminoketone, a N-substituted thioaminoketone, a N-substituted aminoaldehyde, a N-substituted thioaminoaldehyde, a sulfur-containing or oxygen containing azaheterocycle, a boron-containing terminator, a cyclic siloxane, a α-halo-ω-amino alkane, a trialkylsilyl halide, an arylsilyl halide and a alkyl-aryl silyl halide, and wherein the coupling agent is one or more of the following: R*ₙM¹Y₍₄₋ₙ₎, M¹Y₄, and M²Y₃ wherein each R* is independently a monovalent organic group having 1-20 carbon atoms; M¹ is a tin atom, silicon atom or germanium atom; M² is a phosphorous atom; Y is a halogen atom, an alkoxysilane and/or carboxysilane; and n is an integer of 0-3.

18. The method according to claim 11, wherein the catalyst is one or more of an organo metal compound, salt or metal, and wherein the metal comprises Ni, Ir, Rh, Ru, Os, Pd and Pt compounds,
wherein the average number of grafted units per chain is from about 0.25 to about 15, and
wherein grafting of nitrogen containing functional groups onto main chain varies from 50 ppm to 2200 ppm per polymer chain.

19. The method according to claim 11, wherein the catalyst is platinum(0)-1,3-divinyl-1,1,3,3-tetramethyldisiloxane, and wherein the reaction is performed in a solvent that is a hydrocarbon solvent.

20-22. (canceled)

23. A hydrosilyl-functionalized polydiene polymer, comprising:
a reaction product of i) a polydiene and ii) a silylating grafting agent having the formula: 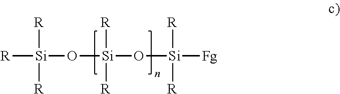
wherein n is an integer from 0 to 8, 25 or 150 and each R individually is a hydrogen atom, a halogen atom, a monovalent organic group, or an Fg (as defined below) or where two or more R groups join to form a bond or a polyvalent organic group, with the proviso that at least one R is a hydrogen atom;
wherein Fg is derived from a compound having the formula CH₂=C(R₁)(R₂), wherein at least one of R₁ and R₂ have a functionality that may participate in hydrogen bonding, a chemical reaction with a filler or polymer grafting and one of R₁, and R₂ may be a hydrogen atom or an organic group, or 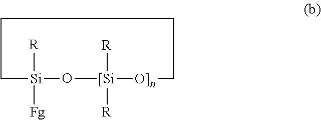
wherein R is a hydrogen atom, a halogen atom, or a monovalent organic group, or another Fg, and wherein Fg is as defined above, and n is 2 to 5

24. The polymer according to claim 23, wherein the compound has the formula CH₂=CHCH₂X—R, wherein X is O or N, and wherein R is polyethylene oxide having from 3 to 100 repeat groups, or is derived from piperidine when X is N or is derived from bis(trimethylsilyl)amine when X is N.

25. The polymer according to claim 23, wherein the polydiene comprises one or more of poly(1,3-butadiene) and a copolymer of butadiene and a comonomer that is one or more of an aromatic vinyl compound and a conjugated diene, wherein the aromatic vinyl compound is styrene, 2-methylstyrene, 3-methylstyrene, 4-methylstyrene, 2,4-dimethylstyrene, 2,4,6-trimethylstyrene, alpha-methylstyrene, 2,4-diisopropylstyrene, 4-tert-butylstyrene, stilbene, vinyl benzyl dimethylamine, (4-vinylbenzyl)dimethyl aminoethyl ether, N,N-dimethylaminoethyl styrene, tert-butoxystyrene, vinylpyridine, 1,2-divinylbenzene, 1,3-divinylbenzene or 1,4-divinylbenzene, or a combination thereof, wherein the aromatic vinyl compound constitutes from 0 to 50 wt. % of the total monomer content of the copolymer.

26. The polymer according to any of claim 25, wherein the conjugated diene is 1,3-butadiene, 2-(C1-C5 alkyl)-1,3-butadienes such as isoprene (2-methyl-1,3-butadiene), 1,3-pentadiene, 2,4-hexadiene, 1,3-hexadiene, 1,3-heptadiene, 1,3-octadiene, 2-methyl-2,4-pentadiene, cyclopentadiene, 2,4-hexadiene, 1,3-cyclohexadiene or 1,3-cyclooctadiene, or a combination thereof, and
wherein the copolymer is styrene-butadiene rubber, butadiene-isoprene rubber or butadiene-isoprene-styrene rubber, with a styrene content of from 5 to 50% by weight of total monomer content of the copolymer.

27. (canceled)

28. The polymer according to claim 23, the average number of grafted units per chain is from about 0.25 to about 15, alternatively from about 2 to about 8.

29. The polymer according to claim 23, wherein grafting of nitrogen containing functional groups onto main chain varies from 50 ppm to 2200 ppm per polymer chain, or
wherein the polymer has a weight average molecular weight of about 75,000 q/mol to about 1,000,000 g/mol, or
wherein the polymer has a number average molecular weight of about 75,000 q/mol to about 1,000,000 g/mol.

30-31. (canceled)
